(19) United States
(12) Patent Application Publication
(10) Pub. No.: US 2014/0191987 A1
(43) Pub. Date: Jul. 10, 2014

(54) DATA TRANSMISSION DEVICE AND METHOD FOR TRANSMITTING DISPLAY AND TOUCH DATA AND COMPUTER SYSTEM HAVING THE SAME

(71) Applicant: Quanta Computer Inc., Taoyuan Shien (TW)

(72) Inventor: Hsin-Chi LIN, New Taipei City (TW)

(73) Assignee: Quanta Computer Inc., Taoyuan Shien (TW)

(21) Appl. No.: 13/965,786

(22) Filed: Aug. 13, 2013

(30) Foreign Application Priority Data
Jan. 7, 2013 (TW) 102100469

(51) Int. Cl. G06F 3/041

(52) U.S. Cl. CPC G06F 3/0416
USPC 345/173

(57) ABSTRACT

A data transmission device for transmitting display and touch data used in a computer system having a touch display device is provided. The touch display device has a display panel and a touch panel. The data transmission device comprises a display panel data storage module for storing display default data, a touch control module for generating at least one touch signal according to at least one touch action on the touch panel, a display panel signal transmission interface and a signal transmission module. The signal transmission module retrieves the display panel setting data through at least one specific pin of the display panel signal transmission interface in a display panel initialization time, and receives the touch signal through the same specific pin after the display panel initialization time.

### RELATED APPLICATIONS

This application claims priority to Taiwan Application Serial Number 102100469, filed Jan. 7, 2013, which is herein incorporated by reference.

### BACKGROUND

1. Technical Field

The present disclosure relates to a touch and display data transmission technology. More particularly, the present disclosure relates to a computer system and the data transmission device and method for transmitting display data and touch data.

2. Description of Related Art

Touch input technology is a very intuitive input method. Therefore, the touch display devices equipped with the touch technology become the mainstream devices of the computer system. Currently, the system design related to the touch panel and the display panel that are independent to each other needs to consider their individual connection wires, mechanism designs and the electronic characteristic, etc. however, under the trend of ultra-thin device design, the integration of the touch panel and display device becomes difficult. For example, the clamshell notebook uses the hinge to contain the connection wires between the host and the display panel. Since the hinge has a limited amount of space, it is very hard to additionally dispose the wires for connecting the touch panel and the host.

The above issues result in additional costs. Further, the design of the touch panel is not easy to standardized due to the additional parameters and consideration related to the above issues. Nevertheless, the principle of the design of electronic products nowadays is to simplify the design and to establish the standard and the commonness of the design.

Accordingly, what is needed is a computer system and the data transmission device and method for transmitting display data and touch data to integrate and simplify the system and the connection interface to accomplish an elastic design of their architecture.

### SUMMARY

A data transmission device for transmitting display data and touch data use in a computer system having a touch display device is provided. The touch display device comprises a display panel and a touch panel. The data transmission device comprises a display panel data storage module, a touch control module, a display panel signal transmission interface and a signal transmission module. The display panel data storage module is disposed in the touch display device to store at least one piece of display panel setting data. The touch control module is disposed in the touch display device to generate at least one touch signal according to at least one touch action on the touch panel. The signal transmission module is disposed in a host of the computer system. The signal transmission module retrieves the piece of display panel setting data from the display panel data storage module through at least one specific pin of the display panel signal transmission interface in a display panel initialization time period. The signal transmission module receives the touch signal from the touch control module through the same specific pin after the display panel initialization time period.

Another aspect of the present invention is to provide a data transmission method for transmitting display data and touch data use in a data transmission device disposed in a computer system having a touch display device. The data transmission method comprises the steps outlined below. A piece of display panel setting data is retrieved by a signal transmission module from a display panel data storage module through at least one specific pin of a display panel signal transmission interface in a display panel initialization time period. A display panel comprised in the touch display device is initialized. At least one piece of setting data is transmitted by the signal transmission module to a touch control module of the data transmission device through the same specific pin after the display panel initialization time period. A touch panel of the touch display device is initialized according to the piece of setting data. At least one touch signal is generated by the touch control module according to at least one touch action on the touch panel. The touch signal is received by the signal transmission module from the touch control module through the same specific pin.

Yet another aspect of the present invention is to provide a computer system. The computer system comprises a touch display device comprising a display panel and a touch panel, a host and a data transmission device. The data transmission device comprises a display panel data storage module, a touch control module, a display panel signal transmission interface and a signal transmission module. The display panel data storage module is disposed in the touch display device to store at least one piece of display panel setting data. The touch control module disposed in the touch display device to generate at least one touch signal according to at least one touch action on the touch panel. The signal transmission module is disposed in the host. The signal transmission module retrieves the piece of display panel setting data from the display panel data storage module through at least one specific pin of the display panel signal transmission interface in a display panel initialization time period. The signal transmission module receives the touch signal from the touch control module through the same specific pin after the display panel initialization time period.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a computer system in an embodiment of the present invention;

FIG. 2 is a simplified block diagram of the data transmission device in an embodiment of the present invention;

FIG. 3A and FIG. 3B are the flow charts of the data transmission method for transmitting display data and touch data in an embodiment of the present invention;

FIG. 4 is a flow chart of the data transmission method for transmitting display data and touch data in an embodiment of the present invention;

FIG. 5 is a simplified block diagram of the data transmission device in another embodiment of the present invention;

FIG. 6 is a block diagram of the computer system in an embodiment of the present invention;

FIG. 7 is a block diagram of the computer system in an embodiment of the present invention;

FIG. 8A and FIG. 8B are block diagrams of the computer systems respectively in an embodiment of the present invention;

FIG. 9 is a diagram of the pin arrangements under different designs of display interfaces and touch panels in an embodiment of the present invention;

FIGS. 10A-10D are block diagrams of the display panel control board and display panel that support the eDP interface in an embodiment of the present invention;

FIGS. 11A-11C are diagrams of the pin arrangements (1)-(3) in an embodiment of the present invention;

FIGS. 12A-12E are diagrams of the pin arrangement (4)-(8) in an embodiment of the present invention; and

FIGS. 13A-13E are diagrams of the pin arrangements (9)-(13) in an embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

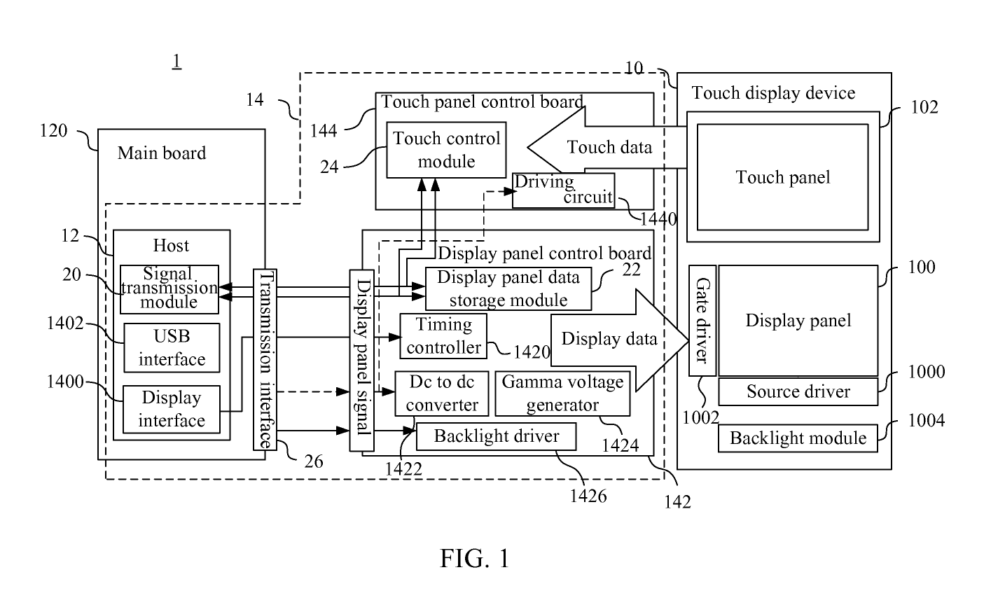

FIG. 1 is a block diagram of a computer system 1 in an embodiment of the present invention. The computer system 1 comprises a touch display device 10, a host 12 and a data transmission device 14.

The touch display device 10 comprises a display panel 100 and a touch panel 102. The display panel 100 generates display frame thereon according to the display data sent by the host 12 for a user to observe. In the present embodiment, a source driver 1000, a gate driver 1002 and a backlight module 1004 are presented to provide data and light source of the display panel 100 to generate the display frame.

The touch panel 102 generates sensing data according to touch actions of a user and transmits the sensing data to the host 12 such that the host 12 determines the positions of the touch actions. In different embodiments, the touch panel 102 is of the type of such as, but not limited to, capacitive touch panel, resistive touch panel, surface acoustic wave touch panel or optics touch panel. The host 12 can generate the display data from such as, but not limited to, the processing module disposed therein and determine the touch positions according to the sensing data from the touch panel 102.

The data transmission device 14 is used to transmit the touch data and the display data between the host 10 and the touch display device 10.

In an embodiment, the data transmission device 14 includes a corresponding transmission interface at the host 12 and the touch display device 10 respectively. At the host 12, the data transmission device 14 includes a display interface 1400′ a signal transmission module 20 and a Universal Serial Bus interface 1402 that are formed on a main board 120 to transmit and receive signals of different formats.

At the touch display device 10, the data transmission device 14 includes the circuits for operating the display panel 100, such as but not limited to a display panel data storage module 22, a timing controller 1420, a dc to dc converter 1422, a gamma voltage generator 1424 and a backlight driver 1426 that are formed on a display panel control board 142. At the touch display device 10, the data transmission device 14 further includes the circuits for operating the touch panel 102, such as but not limited to a driving circuit 1440 and a touch control module 24 that are formed on a touch panel control board 144. It is noted that the display panel control board 142 and the touch panel control board 144 may be implemented as two independent circuit boards or as two blocks in the same circuit board.

The display panel signal transmission interface 26 is used to perform data transmission and communication between the host 12 and the touch display device 10. The display panel signal transmission interface 26 includes pins (not shown) and cables to transmit data of different contents and formats. Each of pins serves as a data transmission channel.

For example, the display data generated from the host 12 is sent to the timing controller 1420 through the display interface 1400. The display interface 1400 can be such as, but not limited to a low-voltage differential signaling (LVDS) interface or an embedded display port (eDP) interface. Other signals, such as the signals for generating panel driving voltage, for generating gamma correction voltage and for driving the backlight module 1004, can be transmitted from the host 12 to the dc to dc converter 1422, the gamma voltage generator 1424 and the backlight driver 1426.

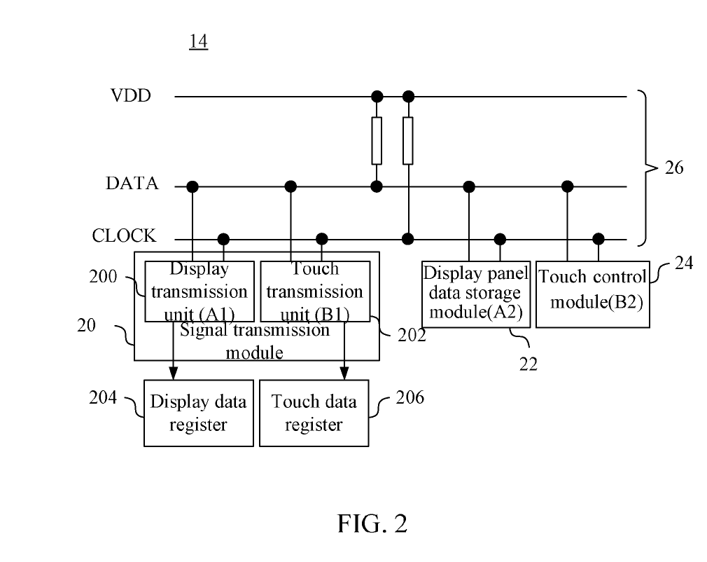

FIG. 2 is a simplified block diagram of the data transmission device 14 in an embodiment of the present invention. In FIG. 2, the signal transmission module 20, the display panel data storage module 22, the touch control module 24 and the display panel signal transmission interface 26 are depicted.

In the present embodiment, the signal transmission module 20 includes a display transmission unit (DTU) 200 (A1) and a touch transmission unit (TTU) 202 (B1). The operation of these two units is further discussed in the subsequent paragraphs.

The display panel data storage module 22 stores at least one piece of display panel setting data. In an embodiment, the display panel data storage module 22 is such as, but not limited to, an electrically-erasable programmable read-only memory (EEPROM). The display panel data includes such as but not limited to the parameters of the extended display identification data (EDID) to store the vendor of the manufacturer, the serial number and the basic display parameters such as the default resolution, the hue, and the vertical and horizontal dimensions of the display panel 100.

The touch control module 24 (B2) is disposed in the touch display device 10. The touch control module 24 generates the touch signal when it receives the touch data generated according to the touch action applied on the touch panel 102. The display panel signal transmission interface 26 in the present embodiment includes a specific channel (i.e. a specific pin) supporting the I2C interface and further includes the channels for transmitting the supply voltage VDD, the data transmission path DATA and the clock transmission path CLOCK.

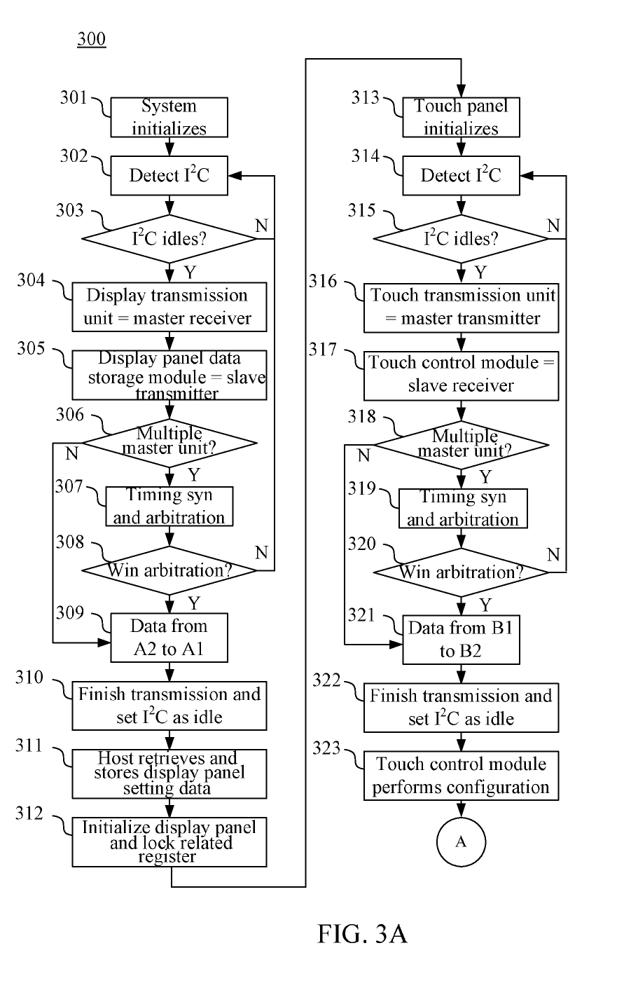

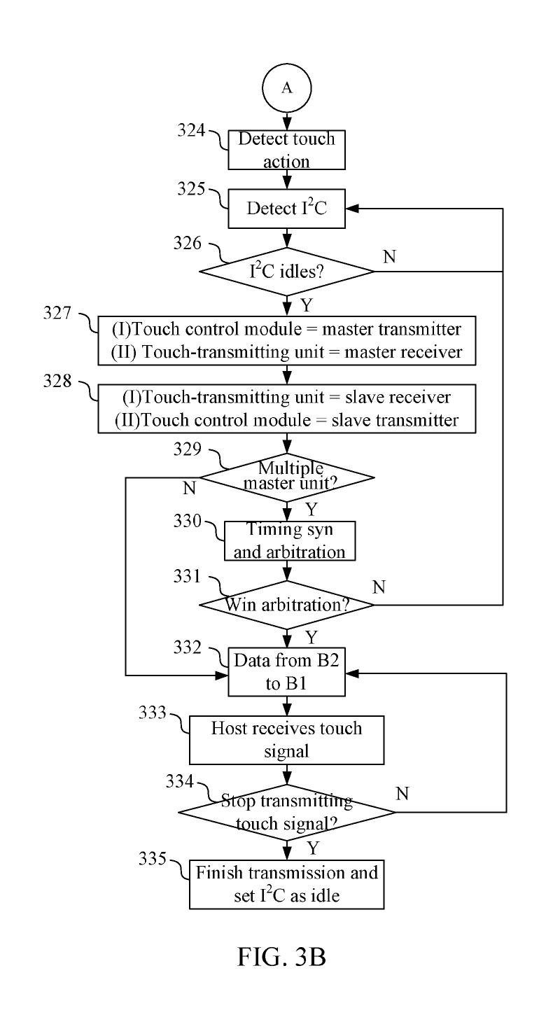

FIG. 3A and FIG. 3B are the flow charts of the data transmission method 300 for transmitting display data and touch data in an embodiment of the present invention. The detail description of the operation of the signal transmission module 20 is discussed along with FIG. 3.

In step 301, the system is activated to perform the initialization. The system enters the display panel initialization time period. In step 302, the display transmission unit 200 performs detection on the I2C interface and further determines whether the I2C interface idles in step 303. When the I2C interface is occupied, the flow goes back to step 302 to keep performing the detection. When the I2C interface idles, the display transmission unit 200 is set to be the master receiver in step 304. The display panel data storage module 22 is set to be the corresponding slave transmitter in step 305.

In step 306, the display-transmitting unit 200 further determines that whether there are a multiple of master units on the I2C interface. If there are a multiple of master units, the display-transmitting unit 200 performs the timing synchronization and arbitration in step 307 and determines whether it wins the arbitration in step 308. When it does not win the arbitration, the flow goes back to step 302 to keep performing the detection.

When the display-transmitting unit 200 wins the arbitration in step 308 or determines that there is only one unit on the I2C interface in step 306 the flow goes to step 309 to transmit the display panel setting data from the display panel data storage module 22 (A2) to the display transmission unit 200 (A1). In step 310, after the transmission is finished, the display transmission unit 200 sets the I2C interface as the idle state. In step 311, the host 12 retrieves and stores the display panel setting data. In step 312, the display panel 100 performs initialization according to the display panel setting data during the display panel initialization time period.

In the present embodiment, the display transmission unit 200 stores the received display panel setting data in the display data register 204. In the present embodiment, the data value stored in the display data register 204 is locked after the display panel initialization time period.

In step 313, the touch panel 102 performs the initialization after the display panel is initialized. Similarly, the touch transmission unit 202 performs detection on the I2C interface and determines whether the I2C interface idles in step 314 and step 315 respectively. When the I2C interface is occupied, the flow goes back to step 314 to keep performing the detection. When the I2C interface idles, the touch transmission unit 202 is set to be the master transmitter in step 316 and the touch control module 24 is set to be the corresponding slave receiver in step 317.

In step 318, the touch-transmitting unit 202 further determines that whether there are a multiple of master units on the I2C interface. If there are a multiple of master units, the touch-transmitting unit 202 performs the timing synchronization and arbitration in step 319 and determines whether it wins the arbitration in step 320. When it does not win the arbitration, the flow goes back to step 314 to keep performing the detection.

When the touch-transmitting unit 202 wins the arbitration in step 320 or determines that there is only one unit on the I2C interface in step 318, the flow goes to step 321 to transmits the setting data from the touch-transmitting unit 202 (B1) to the touch control module 24 (B2). In step 322, after the transmission is finished, the touch-transmitting unit 202 sets the I2C interface as the idle state. In step 323, the touch control module 24 performs configuration. Subsequently, the flow goes to point A.

Refer to FIG. 3B. The flow in FIG. 3B is performed after the point A depicted in FIG. 3A. In step 324, the touch action is detected. Each of the to subsequent steps can be split into two conditions according to the relation of the touch-transmitting unit 202 and the touch control module 24.

At first, in condition (I), the touch control module 24 performs detection on the I2C interface to determine whether the I2C interface idles in step 325 and step 326 respectively. When the I2C interface is occupied, the flow goes back to step 325 to keep performing detection. When the I2C interface idles, the touch control module 24 is set to be the master transmitter in step 327 and the touch-transmitting unit 202 is set to be the corresponding slave receiver in step 328.

In step 329, the touch control module 24 further determines that whether there are a multiple of master units on the I2C interface. If there are a multiple of master units, the touch control module 24 performs the timing synchronization and arbitration in step 330 and determines whether it wins the arbitration in step 331. When it does not win the arbitration, the flow goes back to step 325 to keep performing the detection.

When the touch control module 24 wins the arbitration in step 331 or determines that there is only one unit on the I2C interface in step 329, the flow goes to step 332 to transmit the setting data from the touch control module 24 (B2) to the touch-transmitting unit 202 (B1). In step 333, the host 12 receives the touch signal. In step 334, the touch control module 24 determines whether the touch signal stops to be transmitted such that the touch control module 24 keeps the transmission when the touch signal does not stop to be transmitted. When the touch control module 24 determines that the touch signal stops to be transmitted, the I2C interface is set as idle state in step 335 to finish the touch transmission flow.

On the other hand, in condition (II), the touch-transmitting unit 202 performs detection on the I2C interface to determine whether the I2C interface idles in step 325 and step 326 respectively. When the I2C interface is occupied, the flow goes back to step 325 to keep performing detection. When the I2C interface idles, the touch-transmitting unit 202 is set to be the master receiver in step 327 and the touch control module 24 is set to be the corresponding slave transmitter in step 328.

In step 329, the touch-transmitting unit 202 further determines that whether there are a multiple of master units on the I2C interface. If there are a multiple of master units, the touch-transmitting unit 202 performs the timing synchronization and arbitration in step 330 and determines whether it wins the arbitration in step 331. When it does not win the arbitration, the flow goes back to step 325 to keep performing the detection.

When the touch-transmitting unit 202 wins the arbitration in step 331 or determines that there is only one unit on the I2C interface in step 329, the flow goes to step 332 to transmit the setting data from the touch control module 24 (B2) to the touch-transmitting unit 202 (B1). In step 333, the host 12 receives the touch signal. In step 334, the touch-transmitting unit 202 determines whether the touch signal stops to be transmitted such that the touch-transmitting unit 202 keeps the transmission when the touch signal does not stop to be transmitted. When the touch-transmitting unit 202 determines that the touch signal stops to be transmitted, the I2C interface is set as idle state in step 335 to finish the touch transmission flow.

However, in the present embodiment, after the display panel 100 finishes initialization, the display-transmitting unit 200 and the touch-transmitting unit 202 may act as two master unit to occupy the same channel at the same time (such as the transmitting unit 200 and the touch control module 24 in condition (I) and the display-transmitting unit 200 and the touch-transmitting unit 202 in condition (II)). When the display-transmitting unit 200 retrieves the display panel setting data during the touch signal receiving process of the touch-transmitting unit 202, the transmission of the touch signal is affected such that the touch detection process becomes unstable.

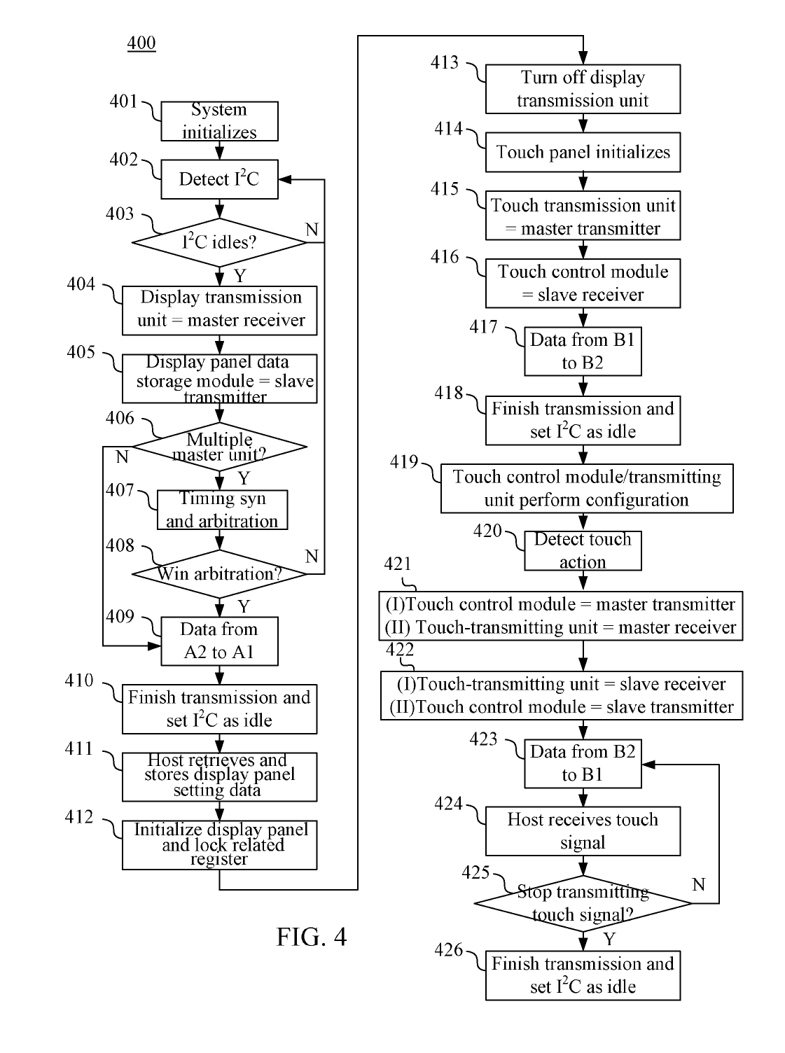

FIG. 4 is a flow chart of the data transmission method 400 for transmitting display data and touch data in an embodiment of the present invention. In the present embodiment, steps 401-412 is actually the same as the steps 301-312 depicted in FIG. 3A. Therefore, steps 401-412 are not discussed herein. In the current flow, in step 413, the display-transmitting unit 200 is turned off after the display panel initialization time period after step 412.

In step 414, the touch panel 102 performs initialization after the display panel initialization time period. In an embodiment, the touch control module 24 is set to be the slave after the initialization. Since the display-transmitting unit 200 is turned off, there is only one master unit on the I2C interface, i.e. the touch-transmitting unit 202. Consequently, the arbitration step and other related determination steps in FIG. 3A and FIG. 3B can be omitted. The touch-transmitting unit 202 is directly set as the master transmitter and the touch control module 24 is set as the corresponding slave receiver in step 415 and 416 of the current flow. The setting data is transmitted from the touch-transmitting unit 202 (B1) to the touch control module 24 (B2) in step 417.

It is noted that the initialization process described above is simply a possible example. In other embodiments, the initialization of the touch control module 24 can be performed by using other methods. For example, in an embodiment, the touch control module 24 does not need to receive the setting data from the touch-transmitting unit 202. A storing unit can be disposed on the touch panel control board 144 to store the setting data such that the touch control module 24 can retrieve the setting data during the initialization.

In step 418, after the transmission is finished, the touch-transmitting unit 202 sets the I2C interface as the idle state. In step 419, the touch control module 24 and the touch-transmitting unit 202 perform the configuration process. The configuration process determines which one of the touch control module 24 and the touch-transmitting unit 202 is the master unit to perform the subsequent steps (steps 420-426) in a way similar to the steps 324-335 in FIG. 3B except the arbitration step and other related determination steps (i.e. steps 325-326 and steps 329-331). Hence, the touch control module 24 and the touch-transmitting unit 202 can accomplish the touch signal transmission mechanism under the condition (I) and condition (II) as the previous embodiment after the configuration process. No more detail is discussed herein.

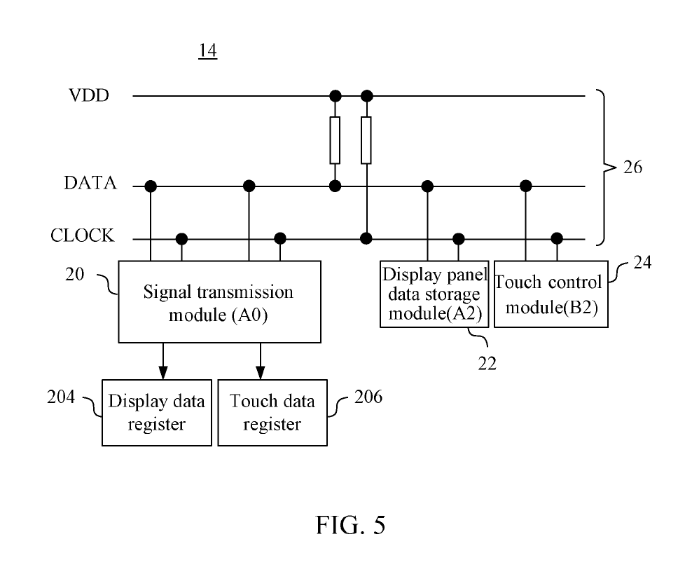

FIG. 5 is a simplified block diagram of the data transmission device 14 in another embodiment of the present invention. In FIG. 5, the signal transmission module 20, the display panel data storage module 22, the touch control module 24 and the display panel signal transmission interface 26 are depicted.

In the present embodiment, the signal transmission module 20 (A0) is a single transmission module, which is different from the transmission module that includes two independent transmission units shown in FIG. 2. The signal transmission module 20 can switch between the roles for transmitting display signals and touch signals. Therefore, the operation flow of the signal transmission module 20 is similar to FIG. 4 without having the arbitration step and the related determination steps in FIG. 3A and FIG. 3B.

It is noted that the common transmission path between the display panel is control board 142 and the touch panel control board 144 can be constructed either with a connector or without the connector. In an embodiment, the two boards can be connected by using anisotropic conduction film (ACF) or by using hot-bar process.

In another embodiment, the driving circuit 1440 of the touch panel control board 144 and the dc to dc converter 1422 of the display panel control board 142 can share the same transmission path, such as the path depicted as a dashed line in FIG. 1, on the display panel signal transmission interface 26 to transmit the driving voltage. However, the chance of the occurrence of the conflict condition of the signals between different sources is lower, the conflict resolving mechanism described above is not necessary.

Accordingly, the design of the data transmission device and method described above can share parts of the data transmission channels between the host and the touch display device, especially the integration of the display data channel for transmitting the display panel setting data and the I2C channel for transmitting the touch panel data to reduce the number of the pins. The conflict generated due to the sharing of the transmission path can be resolved by the design of the present invention. Not only the number of the transmission paths can be reduced to simplify the signal transmission between the host and the touch display device, but also a flexible design method can be realized. Further, the saved pins due to the integration of different channels can be used to implement the channels for transmitting the signals of other formats, such as the Universal Serial Bus shown in FIG. 1. The co-design of the Universal Serial Bus and the I2C bus can be realized.

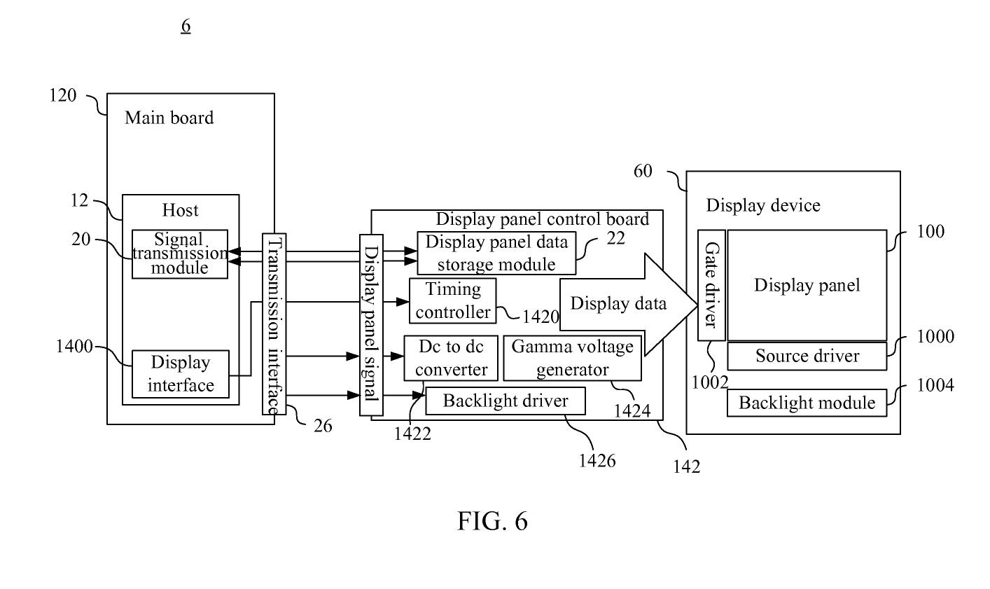

FIG. 6 is a block diagram of the computer system 6 in an embodiment of the present invention. The computer system 6 includes the host 12 and the display device 60 that does not support the touch function. Under such a condition, it does not need to modify the circuit board of the host 12 to upgrade the display device to a touch display device. By using the concept of the system design and the software flow described above, the computer system 6 can be upgraded to the computer system 1 shown in FIG. 1. The cost of the circuit design, layout design, verification, manufacturing and time generated due to the re-design of the circuit board in the host 12 can be saved. Further, the factory cost and the management cost of multiple models can be neglected.

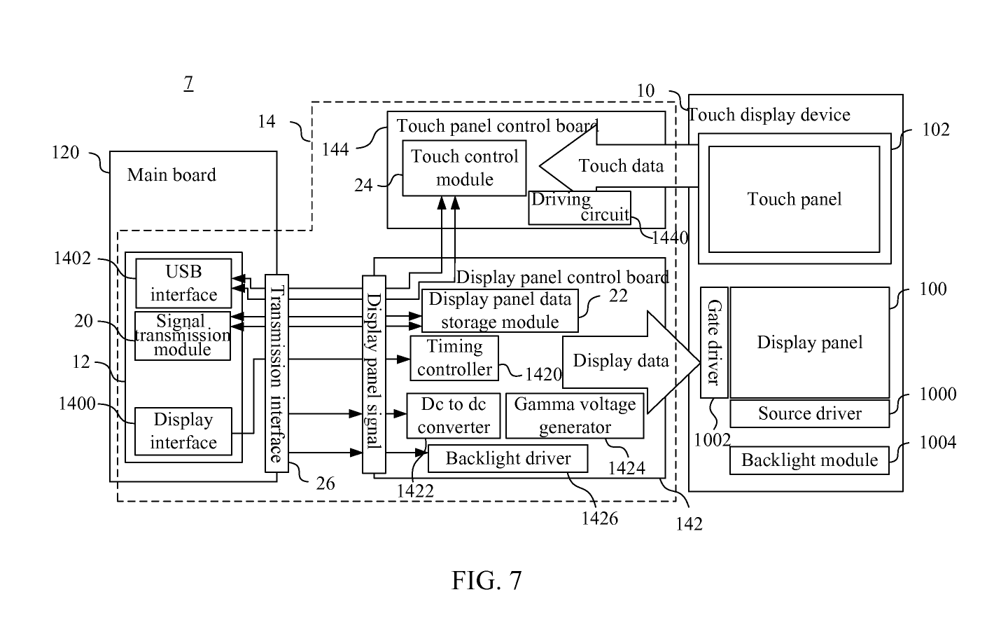

FIG. 7 is a block diagram of the computer system 7 in an embodiment of the present invention. The computer system 7 includes the host 12 and the touch display device 70 similar to those of FIG. 1. However, in the touch display device 70, if the touch control module 24 in the touch panel 102 supports the interface of Universal Serial Bus, the circuit board in the host 12 is still compatible to this kind of touch panel 102 if the touch control module 24 is designed to be connected to the Universal Serial Bus. The re-design of the circuit board is not necessary.

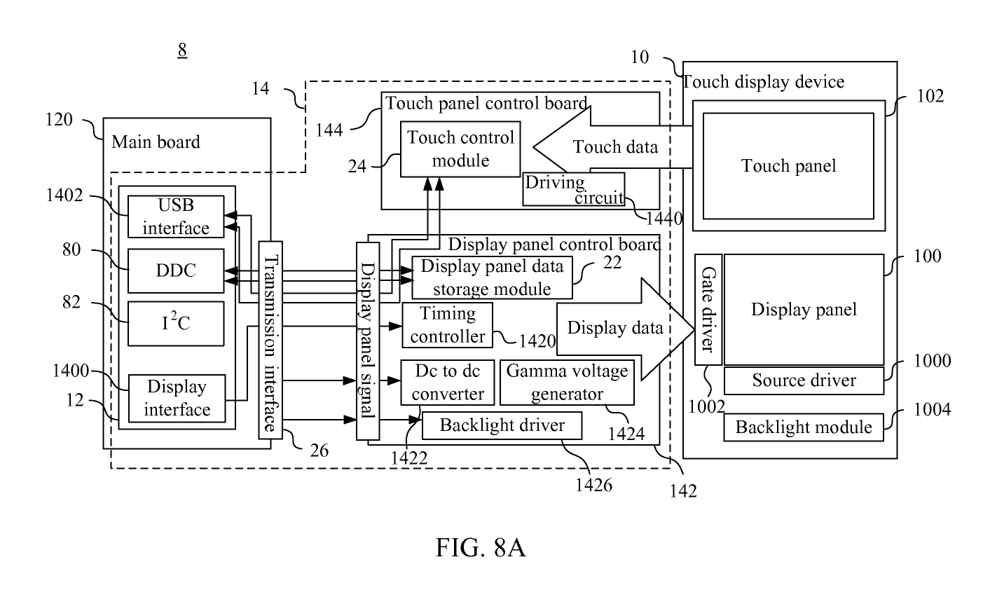

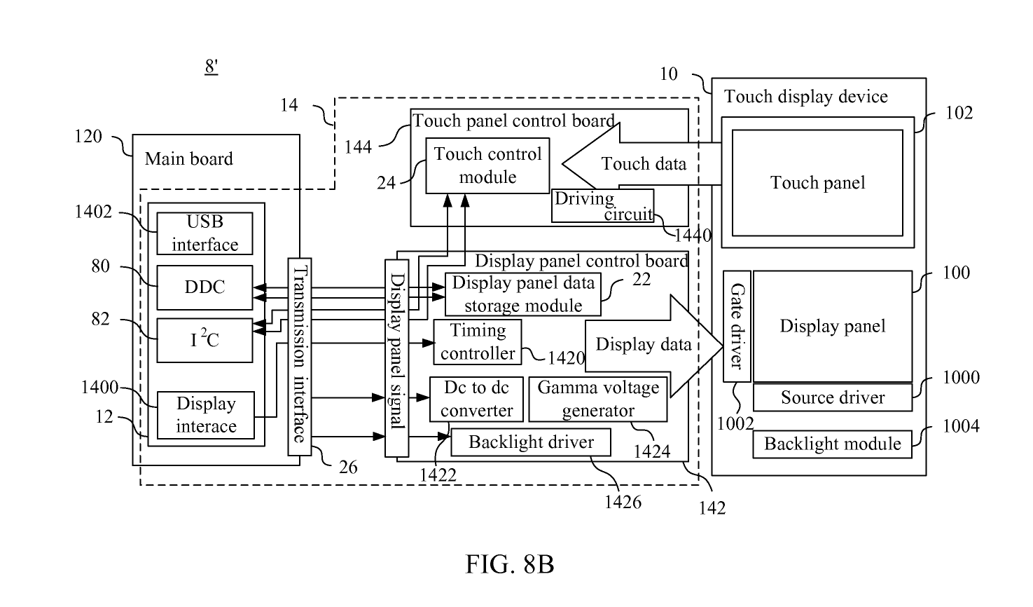

FIG. 8A and FIG. 8B are block diagrams of the computer systems 8 and 8′ respectively in an embodiment of the present invention. In the present embodiment, the signal transmission module 20 further includes the display data channel interface 80 and the I2C channel interface 82. The display data channel interface 80 and the I2C channel interface 82 can be selectively implemented as a single channel or as two independent channels. In FIG. 8A and FIG. 8B, two independent channels are depicted.

The arrangement of the pins of the display panel signal transmission interface 26 defines the channel of the Universal Serial Bus and the I2C as the same pin. Therefore, no matter the touch panel 102 to connected supports the Universal Serial Bus as in FIG. 8A or supports the I2C as in FIG. 8B, it is connected from the same pin. Hence, though this interface can be adapted to the touch panels 102 supporting the Universal Serial Bus and the i2C, the circuit board of the host 12 needs to be designed according to different types of the channels. Using only one circuit board at the host 12 is impossible.

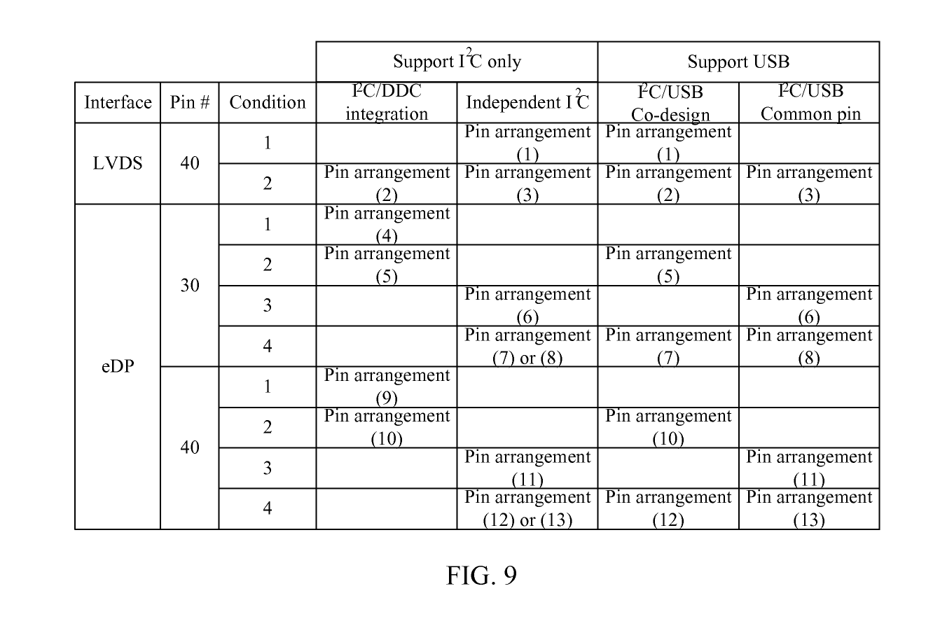

FIG. 9 is a diagram of the pin arrangements under different designs of display interfaces and touch panels in an embodiment of the present invention.

The spec of the touch panel is categorized into four types. When the touch panel supports the I2C channel, the spec is categorized into a type that integrates the I2C channel and the display data channel (DDC) as shown in FIG. 1 and another type that disposes an independent I2C channel. When the touch panel supports the Universal Serial Bus channel, the spec is categorized into a type that co-designs the Universal Serial Bus channel and the I2C channel as shown in FIG. 1 and FIG. 7 and another type that uses common pin definition of the Universal Serial Bus channel and the I2C channel such that the design of the main circuit board depends on different conditions.

As described above, the display interface 1400 uses low voltage differential signal (LVDS) interface in an embodiment of the present invention. When the LVDS interface is used, a single channel type or a dual channel type is used due to the different resolutions. Therefore, the applicable pin definition includes the arrangements (1), (2) and (3) shown in FIG. 9. The arrangement (1) is used together with the single channel LVDS interface and the arrangements (2) and (3) are used together with either the single or dual channel LVDS interface and supports at most to dual channel LVDS interface. The detail is described in the subsequent paragraphs.

On the other hand, the display interface 1400 uses embedded display port (eDP) interface. According to the resolution supported by the display panel 100 and the number of channels that the eDP interface supports, a design of 30 pins and a design of a 40 pins are categorized. The design of 30 pins supports both the single channel and the dual channel and provides the pin arrangements (4)-(8). The design of 40 pins supports up to four channels and provides the pin arrangements (9)-(13).

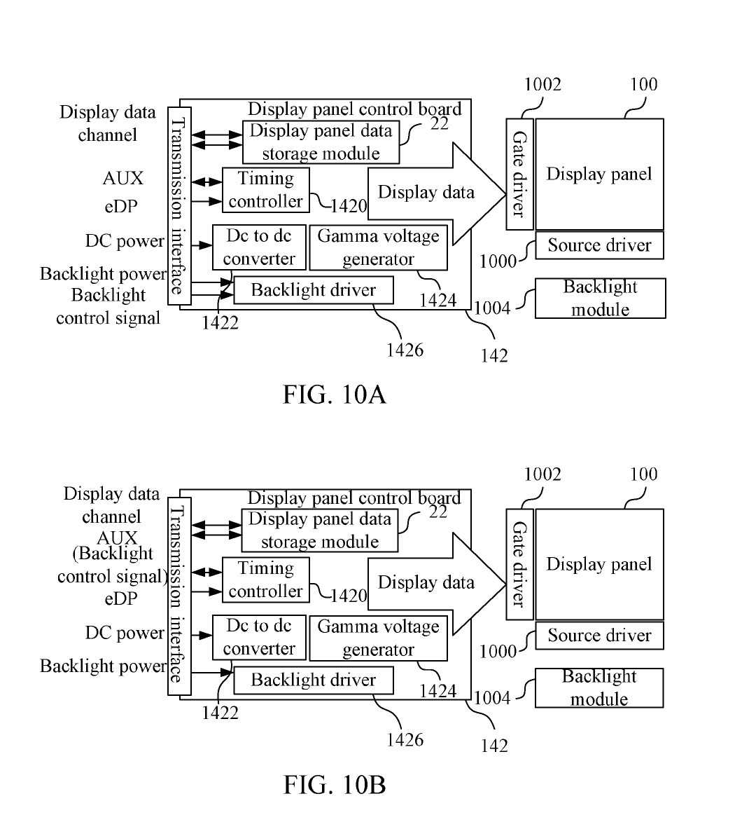

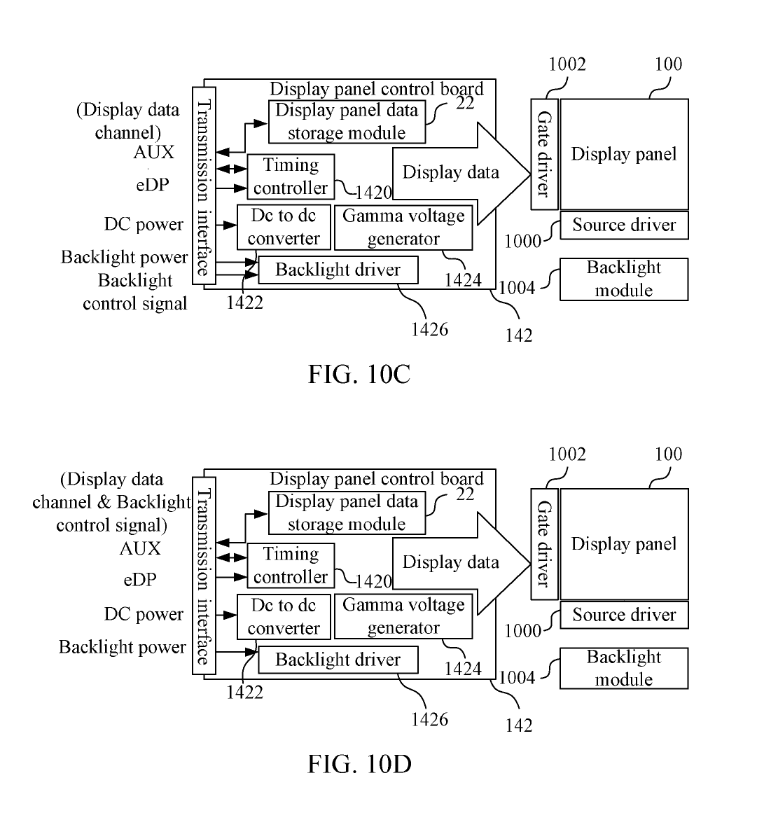

An auxiliary (AUX) channel is disposed in the eDP interface to aid the transmission of parts of the specific signals. According to the combination of the types of the signal transmitted by the AUX channel, four conditions 1-4 is categorized. The detail description is shown together with FIGS. 10A-10D. FIGS. 10A-10D are block diagrams of the display panel control board 142 and display panel 100 that support the eDP interface in an embodiment of the present invention.

In FIG. 10A (corresponding to the condition 1 in FIG. 9), the pins include the display data channel for transmitting the data in the display panel data storage module 22 and the channel for transmitting the backlight control signal that may includes, but not limited to, the backlight enabling signal and the backlight pulse width modulation signal. Under such a condition, the pin arrangement (4) for 30 pins and the pin arrangement (9) for 40 pins are provided.

In FIG. 10B (corresponding to the condition 2 in FIG. 9), the pins include the display data channel. However, since the backlight control signal is transmitted through the AUX channel in the present embodiment, it does not need to define the channel of the backlight control signal additionally. Under such a condition, the pin arrangement (5) for 30 pins and the pin arrangement (10) for 40 pins are provided.

In FIG. 10C (corresponding to the condition 3 in FIG. 9), the pins include the channel for transmitting the backlight control signal. However, since the data of the display data channel is transmitted through the AUX channel in the present embodiment, it does not need to define the display data channel additionally. Under such a condition, the pin arrangement (6) for 30 pins and the pin arrangement (11) for 40 pins are provided.

In FIG. 10D (corresponding to the condition 4 in FIG. 9), the data of the display data channel and the backlight control signal are both transmitted through the AUX channel in the present embodiment. It does not need to define the both of the channels additionally. Under such a condition, the pin arrangements (7) and (8) for 30 pins and the pin arrangements (12) and (13) for 40 pins are provided.

The pin arrangements (1)-(13) are further described in the following paragraphs. FIG. 11A is a diagram of the pin arrangement (1) in an embodiment of the present invention. The pin arrangement (1) is used in the LVDS interface to having a single channel and 40 pins. Such a design provides the pins 20-30 for the touch panel, wherein the pins 20-30 is originally supposed to transmit the even data of the LVDS signal and the differential clock signal. The pins for the I2C channel (pins 20-21) and the pins for the Universal Serial Bus (pins 23-24) can be optional when different main boards are used. Hence, a singular common design can be applied to the circuit of the host or the transmission line of the display panel signal transmission interface to support the touch panels having different interfaces. No redesign is needed.

FIG. 11B is a diagram of the pin arrangement (2) in an embodiment of the present invention. Only the pins 4-7, 20-30 and 33-34 that are different from the pins shown in FIG. 11A are depicted herein. The identical pins are thus omitted.

The pin arrangement (2) is used in either the single channel or the dual channel LVDS interface, especially the high-end panel for high resolution and high scan frequency (i.e. dual channel panel). Hence, pins 20-30 are used to transmit the even signal under the dual channel mode. The main design principal focuses on the common pin for transmitting both the power of the touch panel and the power of the display panel data storage module (pin 4: V_EEDID/TP_V1) and the common pin for transmitting both the clock/data signal of the touch panel and the clock/data signal of the display panel data storage module (pins 6 and 7: CLK EEDID/TP_I2C_CLK, DATA EEDID/TP_I2C_DAT). When the pin arrangement of the present embodiment is used, the common pins described above can be used to transmit the display panel setting data and the touch signal when the touch panel that supports the I2C interface is used.

On the other hand, the pins 33 and 34 are for the Universal Serial Bus. Therefore, the pins for the I2C channel (pins 6-7) and the pins for the Universal Serial Bus (pins 33-34) can be optional when different main boards are used. Hence, a singular common design can be applied to the circuit of the host or the transmission line of the display panel signal transmission interface to support the touch panels having different interfaces. No redesign is needed.

FIG. 11C is a diagram of the pin arrangement (3) in an embodiment of the present invention. Only the pins 6-7 and 33-34 that are different from the pins shown in FIG. 11B are depicted herein. The identical pins are thus omitted.

In the present design, the I2C channel and the Universal Serial Bus channel use common pins. When the touch panel supporting the Universal Serial Bus is used, the pins 33-34 are similar to those depicted in FIG. 11B. When the touch panel supporting the I2C channel, the pins 33-34 are provided to transmit the data and clock signals of the I2C channel, while the pins 6-7 are provided to transmit the display data independently. Only the power of the touch panel and the power of the display panel data storage module are transmitted in a common pin. Such a design is not applied to the old circuit board of the host. However, the layout of the circuit board that supports both the LVDS signal of the display data channel and the I2C channel for the touch panel can be pre-designed first.

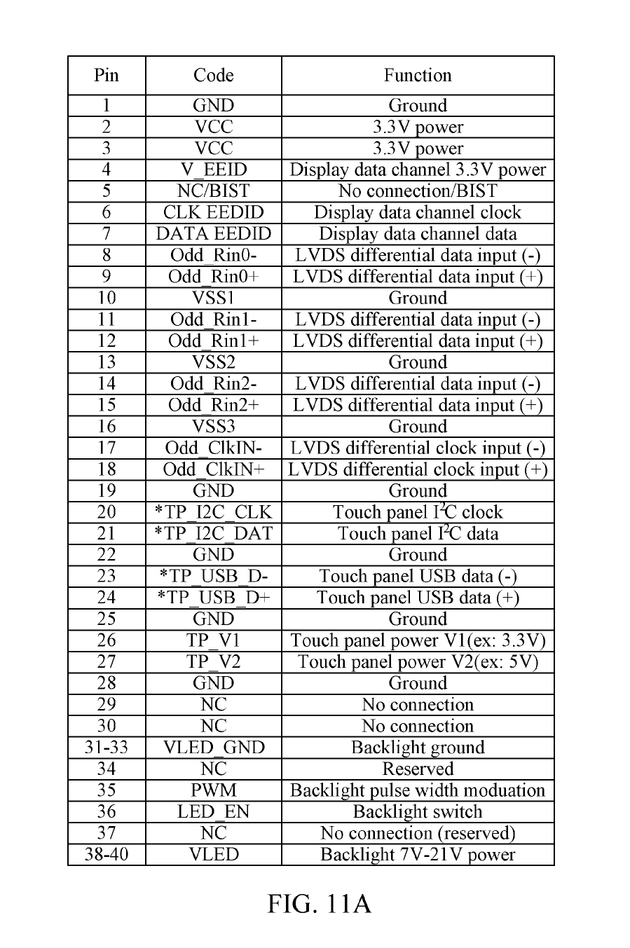

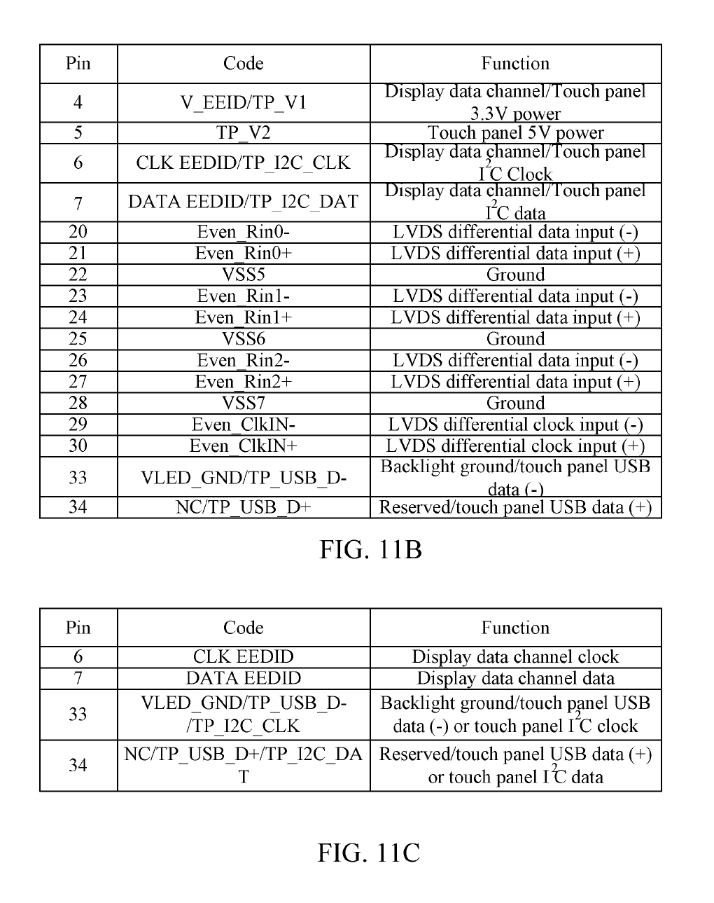

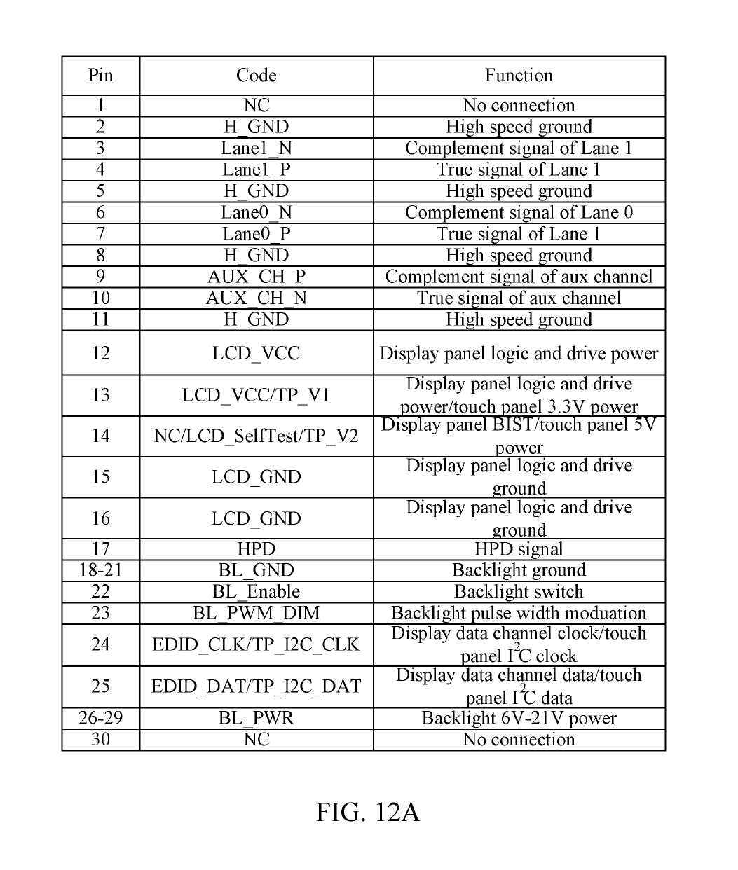

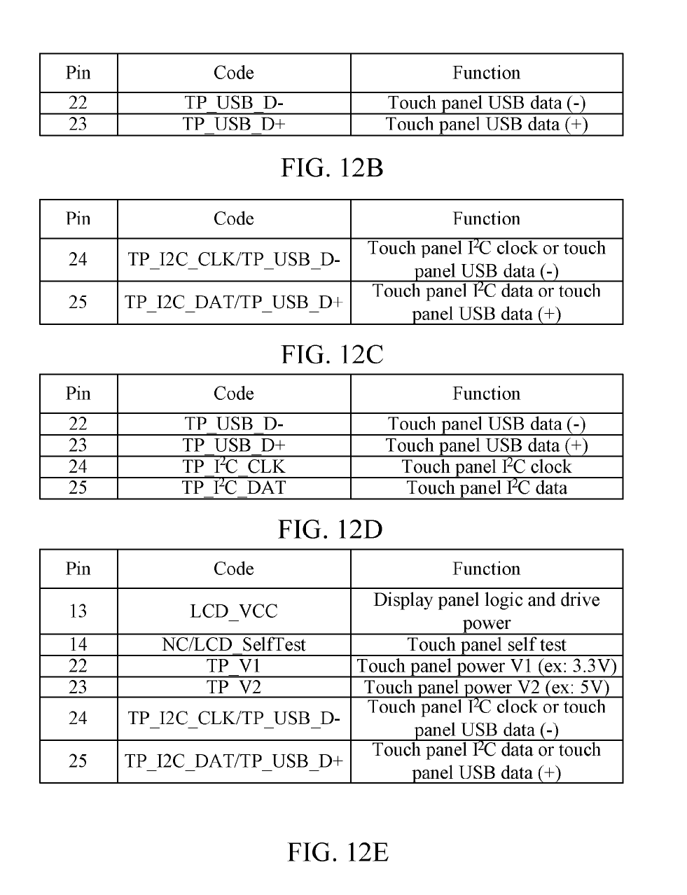

FIG. 12A is a diagram of the pin arrangement (4) in an embodiment of the present invention.

The pin arrangement (4) is used in the eDP interface having 30 pins and corresponds to the condition 1 in FIG. 9. As shown in FIG. 12A, the pins include the display data channel for transmitting data with the display panel data storage module (pins 24-25 that is used in common with the I2C channel of the touch panel) and the channel for transmitting the backlight control signal (pins 22-23).

FIG. 12B is a diagram of the pin arrangement (5) in an embodiment of the present invention. Only the pins 22-23 that are different from those in FIG. 12A are depicted herein. The identical pins are thus omitted.

The pin arrangement (5) is used in the eDP interface having 30 pins too and corresponds to the condition 2 in FIG. 9. In such as design, the pins include the display data channel. The backlight control signal is transmitted by the AUX channel. The pins 22-23 that is originally disposed for transmitting the backlight control signal is modified to be used by the Universal Serial Bus interface. The touch panel supporting the Universal Serial Bus interface can thus be used.

FIG. 12C is a diagram of the pin arrangement (6) in an embodiment of the present invention. Only the pins 22-25 that are different from those in FIG. 12A are depicted herein. The identical pins are thus omitted.

The pin arrangement (6) is used in the eDP interface having 30 pins too and corresponds to the condition 3 in FIG. 9. In such as design, the pins include the channel for transmitting the backlight control signal. The signal of the display data channel is transmitted by the AUX channel. The pins 24-25 can be modified to support the Universal Serial Bus or the I2C channel.

FIG. 12D is a diagram of the pin arrangement (7) in an embodiment of the present invention. Only the pins 22-25 that are different from those in FIG. 12A are depicted herein. The identical pins are thus omitted.

The pin arrangement (7) is used in the eDP interface having 30 pins too and corresponds to the condition 4 in FIG. 9. In such as design, both of the signal of the display data channel and the backlight control signal are transmitted by the AUX channel. The pins 22-23 can be modified to support the Universal Serial Bus and the pins 24-25 can be modified to support the I2C channel to accomplish the co-design of the Universal Serial Bus and the I2C is channels.

FIG. 12E is a diagram of the pin arrangement (8) in an embodiment of the present invention. Only the pins 13-14 and 22-25 that are different from those in FIG. 12A are depicted herein. The identical pins are thus omitted.

The pin arrangement (8) is used in the eDP interface having 30 pins too and corresponds to the condition 4 in FIG. 9. In such as design, both of the signal of the display data channel and the backlight control signal are transmitted by the AUX channel. The difference between the present design and the previous design is that the power of the display panel and the touch panel is not transmitted by the common pins 13-14. The power of the touch panel is transmitted by the pins 22-23. The pins 24-25 are modified to support the Universal Serial Bus or the I2C channel. However, different circuit boards designs are needed to match the present interface design to correspond to the touch panels having different interfaces.

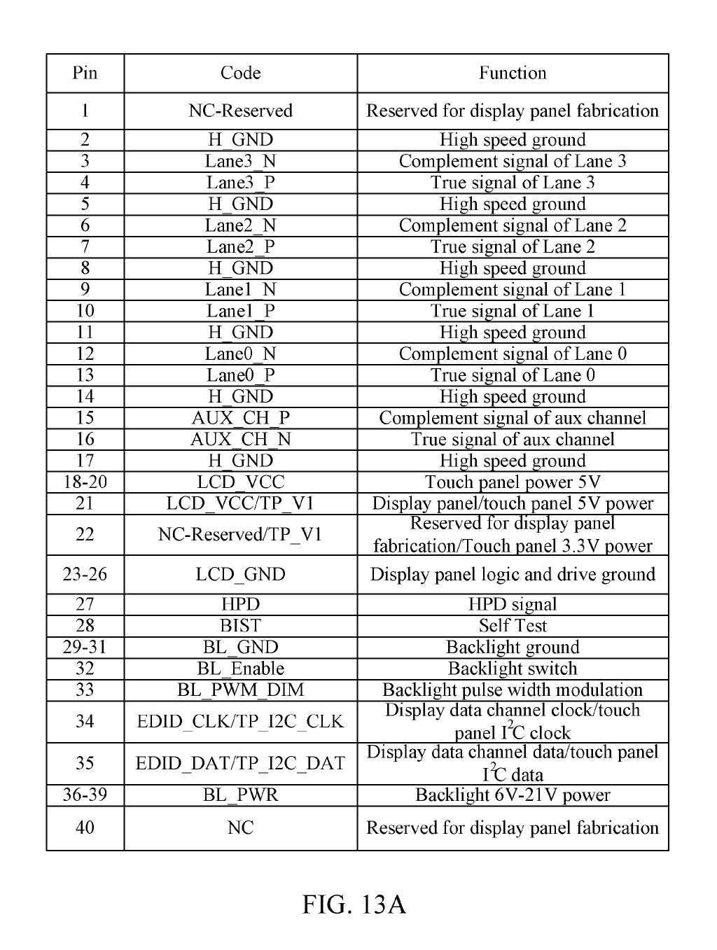

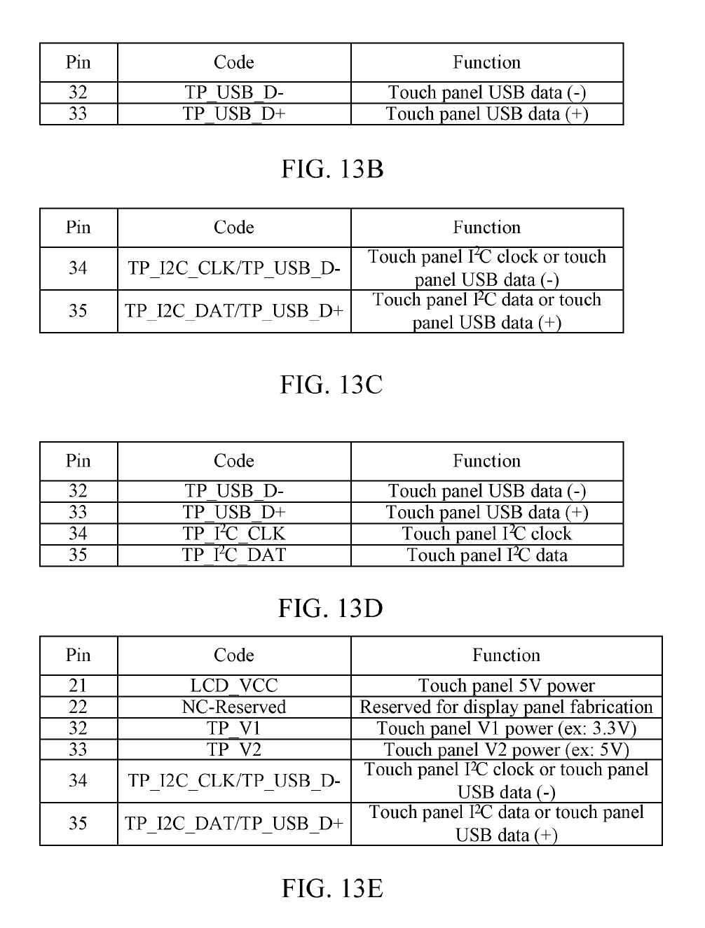

FIGS. 13A-13E are diagrams of the pin arrangements (9)-(13) in an embodiment of the present invention. The pin arrangements (9)-(13) are similar to the pin arrangements (4)-(8). The only difference is that the pin arrangements (4)-(8) are applied to the interface having 30 pins and the pin arrangements (9)-(13) are applied to the interface having 40 pins. Consequently, no more detail is described herein.

From the above disclosed embodiments, different pin designs can be constructed by integrating the display data channel and the I2C channel, by supporting the Universal Serial Bus and the I2C channel and by using AUX channel in the eDP interface to satisfy different needs under different conditions. The design of the connection interface between the host and the touch display panel can be more elastic to match different specifications.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A data transmission device for transmitting display data and touch data use in a computer system having a touch display device, wherein the touch display device comprises a display panel and a touch panel, the data transmission device comprises:
a display panel data storage module disposed in the touch display device to store at least one piece of display panel setting data;
a touch control module disposed in the touch display device to generate at least one touch signal according to at least one touch action on the touch panel;
a display panel signal transmission interface; and
a signal transmission module disposed in a host of the computer system;
wherein the signal transmission module retrieves the piece of display panel setting data from the display panel data storage module through at least one specific pin of the display panel signal transmission interface in a display panel initialization time period;
the signal transmission module receives the touch signal from the touch control module through the same specific pin after the display panel initialization time period.

2. The data transmission device of claim 1, further comprising a display data register and a touch data register disposed in the host, the signal transmission stores the piece of display panel setting data in the display data register and stores the touch signal in the touch data register.

3. The data transmission device of claim 2, wherein a data value stored in the display data register is locked after the display panel initialization time period.

4. The data transmission device of claim 1, wherein the display panel is initialized according to the piece of display panel setting data in the display panel initialization time period.

5. The data transmission device of claim 1, wherein the signal transmission module further transmits at least one piece of setting data to the touch control module after the display panel initialization time such that the signal transmission module receives the touch signal from the touch control module after the touch control module initialize the touch panel according to the piece of setting data.

6. The data transmission device of claim 1, wherein the signal transmission module further comprises:
a display transmission unit to retrieve the piece of display panel setting data from the display panel data storage module through the specific pin of the display panel signal transmission interface in the display panel initialization time; and
a touch transmission unit to receive the touch signal from the touch control module through the same specific pin after the display panel initialization time period.

7. The data transmission device of claim 6, wherein the display transmission unit turns off after the display panel initialization time period.

8. The data transmission device of claim 1, wherein the display panel signal transmission interface is a I2C interface.

9. The data transmission device of claim 1, wherein the piece of display panel setting data comprises an extended display identification data (EDID) and the display panel data storage module is an electrically-erasable programmable read-only memory (EEPROM).

10. A data transmission method for transmitting display data and touch data use in a data transmission device disposed in a computer system having a touch display device, the data transmission method comprises:
retrieving a piece of display panel setting data by a signal transmission module from a display panel data storage module through at least one specific pin of a display panel signal transmission interface in a display panel initialization time period;
initializing a display panel comprised in the touch display device;
transmitting at least one piece of setting data by the signal transmission module to a touch control module of the data transmission device through the same specific pin after the display panel initialization time period;
initializing a touch panel of the touch display device according to the piece of setting data;
generating at least one touch signal by the touch control module according to at least one touch action on the touch panel; and
receiving the touch signal by the signal transmission module from the touch control module through the same specific pin.

11. The data transmission method of claim 10, further comprising:
storing the piece of display panel setting data in a display data register and stores the touch signal in a touch data register.

12. The data transmission method of claim 11, further comprising locking a data value stored in the display data register after the display panel initialization time period.

13. The data transmission method of claim 10, further comprising:
retrieving the piece of display panel setting data by a display transmission unit of the signal transmission module from the display panel data storage module through the specific pin of the display panel signal transmission interface in the display panel initialization time period; and
receiving the touch signal by a touch transmission unit of the signal transmission module from the touch control module through the same specific pin after the display panel initialization time period.

14. The data transmission method of claim 13, further comprising:
turning off the display transmission unit after the display panel initialization time period.

15. A computer system comprising:
a touch display device comprising a display panel and a touch panel;
a host; and
a data transmission device comprising:
a display panel data storage module disposed in the touch display device to store at least one piece of display panel setting data;
a touch control module disposed in the touch display device to generate at least one touch signal according to at least one touch action on the touch panel;
a display panel signal transmission interface; and
a signal transmission module disposed in the host;
wherein the signal transmission module retrieves the piece of display panel setting data from the display panel data storage module through at least one specific pin of the display panel signal transmission interface in a display panel initialization time period;
the signal transmission module receives the touch signal from the touch control module through the same specific pin after the display panel initialization time period.

16. The computer system of claim 15, wherein the data transmission device further comprises a display data register and a touch data register disposed in the host, the signal transmission stores the piece of display panel setting data in the display data register and stores the touch signal in the touch data register.

17. The computer system of claim 16, wherein a data value stored in the display data register is locked after the display panel initialization time period.

18. The computer system of claim 15, wherein the display panel is initialized according to the piece of display panel setting data in the display panel initialization time period.

19. The computer system of claim 15, wherein the signal transmission module further transmits at least one piece of setting data to the touch control module after the display panel initialization time such that the signal transmission module receives the touch signal from the touch control module after the touch control module initialize the touch panel according to the piece of setting data.

20. The computer system of claim 15, wherein the signal transmission module further comprises:
a display transmission unit to retrieve the piece of display panel setting data from the display panel data storage module through the specific pin of the display panel signal transmission interface in the display panel initialization time period; and
a touch transmission unit to receive the touch signal from the touch control module through the same specific pin after the display panel initialization time period.

21. The computer system of claim 15, wherein the display transmission unit turns off after the display panel initialization time period.

22. The computer system of claim 15, wherein the display panel signal transmission interface is a I2C interface.

23. The computer system of claim 15, wherein the piece of display panel setting data comprises an extended display identification data (EDID) and the display panel data storage module is an electrically-erasable programmable read-only memory (EEPROM).
